(19) United States
(12) Patent Application Publication
(10) Pub. No.: US 2024/0043318 A1
(43) Pub. Date: Feb. 8, 2024

(54) GLASS COMPOSITION FOR FUEL CELL STACK SEALING

(71) Applicant: SOLIDpower (Australia) Pty Ltd, Victoria (AU)

(72) Inventors: Sudath Dharma Kumara Amarasinghe, Victoria (AU); Pulahinge Don Dayananda Rodrigo, Victoria (AU); Babak Navak, Victoria (AU)

(73) Assignee: SOLIDpower (Australia) Pty Ltd, Victoria (AU)

(21) Appl. No.: 18/264,395

(22) PCT Filed: Feb. 4, 2022
(86) PCT No.: PCT/AU2022/050058

§ 371 Date: Aug. 4, 2023

(30) Foreign Application Priority Data
Feb. 5, 2021 (AU) 2021900273
Aug. 20, 2021 (AU) 2021218224

(51) Int. Cl. C03C 8/24; H01M 8/0282; H01M 8/1246

(52) U.S. Cl. CPC C03C 8/24; H01M 8/0282; H01M 8/1246; H01M 2008/1293

(57) ABSTRACT

The present invention relates to glass compositions and sealing materials comprising same suitable for use in electrochemical devices requiring a hermetic seal such as solid oxide fuel cell (SOFC) and solid oxide electrolyser cell (SOEC) stacks.

### FIELD OF THE INVENTION

The present invention relates to glass compositions and sealing materials comprising same which are suitable for use in electrochemical devices requiring a hermetic seal, including solid oxide fuel cell stacks and similar apparatus, such as solid oxide electrolyser cell stacks.

### RELATED APPLICATIONS

This application claims priority from Australian provisional patent application AU AU 2021900273 and Australian patent application AU 2021218224, the entire contents of which are hereby incorporated by reference.

### BACKGROUND OF THE INVENTION

Electrochemical devices or electrochemical cells are devices capable of either generating electrical energy from chemical reactions or using electrical energy to cause chemical reactions. An example of an electrochemical device is a solid oxide fuel cell (SOFC) device, which is used to convert chemical energy of a gaseous fuel such as hydrogen into electrical energy by electrochemical oxidation. A typical SOFC stack consists of a number of cells connected to each other, where each cell has a porous ceramic cathode and a porous ceramic anode separated by a dense, ionically conducting solid oxide electrolyte. The stacks typically include a support structure made up of one or more supports made of a suitable material, for example made of suitable metals. During operation of a SOFC stack, a fuel such as natural gas is supplied to the anode and an oxidant such as air is supplied to the cathode of each cell. The cell components are assembled in such a way the fuel and the oxidant can be supplied to the anode and the cathode of each cell respectively. Another example of an electrochemical device is a solid oxide electrolyser cell (SOEC) device, which is essentially an SOFC that runs in regenerative (reverse) mode and achieves electrolysis of water to produce hydrogen gas and oxygen gas.

The cells of SOFC and SOEC devices require gas tight (hermetic) seals which prevent mixing of the fuel and the oxidant and are therefore important for the performance, durability and safe operation of a SOFC or SOEC stack. The seals are commonly used to separate the anode and cathode cavities of SOFC or SOEC stacks from each other and from the surrounding environment as required by the stack design. The seals also allow for mechanical bonding of the components of a SOFC or SOEC stack and electrical insulation between bonded components.

During operation SOFC and SOEC stacks reach elevated temperatures, usually in the range of about 500° C. to about 1000° C., and are subjected to both intentional and unintentional temperature fluctuations (thermal cycles) ranging from as low as ambient temperature to the operating temperature with varying heating and cooling rates. To ensure the commercial viability of SOFC and SOEC stacks, the seals must maintain their integrity and fulfil all the above requirements under the thermal cycling conditions as well as under the constant temperature operation for many thousands of hours. For example, the mismatch between the thermal expansion and contraction of each seal and the other components of the SOFC or SOEC stack should be sufficiently low to prevent the failure of the seal or any of the other components under the thermal stresses developed during thermal cycling. Further, the seal should not have adverse interactions with other components of the SOFC or SOEC stack, either by way of emitting undesirable volatile species that alter the chemical or physical nature of the other components or by reacting with the other components that the seal is in contact with.

Various types of glasses have been developed for use as seals in SOFC and SOEC stacks. One type of glass has been designed to retain a large fraction of liquid-like glassy phase. This provides the glass with the ability to flow (exhibit viscous relaxation) under the thermal stresses generated as the main means of reducing the magnitude of the stresses imparted on the other components and the interfaces with the other components at temperatures above the glass transition temperature (T_{g}). This type of glass has a number of deficiencies. For example, it is typically prone to cracking at temperatures below the T_{g} where the viscous relaxation is absent. In addition, the glass usually contains high amounts of constituents such as alkali oxides and B₂O₃ which can (a) make the seal a poor electrical insulator, (b) either volatilise or get leached out in the humidified gaseous environment within the fuel cell stack, resulting in continuous changes in the chemical and physical properties of the seal, and (c) lead to adverse reactions with the other components.

Another type of glass has been designed to turn into highly crystalline rigid glass-ceramics at the SOFC and SOEC operating temperatures. Whilst this type of highly crystalline glass mitigates the disadvantages relating to the reactivity of the less crystalline glass seals described above, to densify a seal made from this type of glass and eliminate large intrinsic flaws can be extremely difficult. The presence of large intrinsic flaws and the absence of a substantial amount of glassy phase sufficient to reduce stress concentration at the tips of the existing flaws can make this type of glass vulnerable to cracking by the propagation of existing intrinsic flaws under severe thermal cycling.

The above deficiencies can compromise the performance of glass seals currently used in commercial SOFC and SOEC stacks. Accordingly, there is a need for alternative glass seals which are suitable for use in electrochemical devices requiring a hermetic seal such as SOFC and SOEC stacks.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

The present inventors have developed a glass composition which is capable of forming a glass seal suitable for use in a SOFC device. The formed glass seal advantageously comprises one or more crystalline phases and a glassy phase.

In one aspect, the present invention provides a glass composition comprising, as mol % of the glass composition:
about 50 to about 60 mol % SiO₂;
about 2 to about 10 mol % B₂O₃;
about 0.5 to about 3 mol % Al₂O₃;
about 4 to about 6 mol % TiO₂;
about 1 to about 4 mol % CeO₂;
about 2 to about 30 mol % SrO; and
about 2 to about 25 mol % BaO.

In some embodiments of the glass composition, condition (a) and one or both of conditions (b) and (c)are satisfied:

mol % BaO>(2×mol % TiO₂+mol % B₂O₃); (a)

(mol % BaO+mol % SrO−2×mol % TiO₂−mol % B₂O₃)≤0.5×(mol % SiO₂−2×mol % TiO₂−⅔×mol % B₂O₃); (b)

(mol % BaO+mol % SrO−2×mol % TiO₂)/(mol % SiO₂−2×mol % TiO₂)<0.5. (c)

In some embodiments, the glass composition is substantially free of alkali metal oxides.

In another aspect, the present invention provides a sealing material for use in an electrochemical device comprising the glass composition described herein. The electrochemical device may be any electrochemical device that requires a hermetic seal. In preferred embodiments, the electrochemical device is an SOFC or SOEC stack.

In another aspect, the present invention provides an electrochemical device comprising one or more cells, each cell comprising a cathode, an anode and a solid electrolyte; a support structure comprising one or more supports; and the sealing material described herein. The electrochemical device may be any electrochemical device that requires a hermetic seal. In preferred embodiments, the electrochemical device is an SOFC or SOEC stack.

In another aspect, the present invention provides the use of the glass composition described herein or the sealing material described herein for forming a seal in an electrochemical device. The electrochemical device may be any electrochemical device that requires a hermetic seal. In preferred embodiments, the electrochemical device is an SOFC or SOEC stack.

In another aspect, the present invention provides a method of forming a seal in an electrochemical device which is a SOFC or SOEC stack, the method comprising:
applying the sealing material described herein on one or both of a cell and a support structure of a SOFC or SOEC stack; and
subjecting the sealing material to a sintering thermal cycle, wherein the glass composition of the sealing material softens to provide a sintered glass and subsequently undergoes controlled crystallisation to provide a glass-ceramic comprising one or more crystalline phases and a glassy phase;
   thereby forming a seal in the SOFC or SOEC stack.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 is a schematic diagram of a portion of a solid oxide fuel cell stack with cell components shown in an exploded view.

FIG. 2 is a graph of the typical particle size distribution of a glass powder prepared from the glass composition of the invention.

FIG. 3 shows scanning electron microscope images at two different magnifications of a sintered glass sample prepared from a glass composition of the invention.

FIG. 4 is a graph of the expansion difference between the metal used for the support structure of a SOFC stack and the sintered glass bars prepared from glass compositions of the invention.

FIG. 5 is a graph of the expansion difference between the metal used for the support structure of a SOFC stack and the sintered glass bars prepared from a glass composition of the invention which has been subjected to an atmospheric air environment at 850° C. for 0, 1000, 2000, 4000 and 6000 hours.

FIG. 6 shows scanning electron microscope images of sintered glass bars prepared from a glass composition of the invention which have been air aged at 850° C. at 0, 1000, 2000 and 6000 hours.

FIG. 7 is a graph of the expansion difference between the metal used for the support structure of a SOFC stack and sintered glass bars prepared from a glass composition of the invention which has been subjected to a fuel environment at 850° C. for 0, 1000, 2000, 4000 and 6000 hours.

FIG. 8 shows scanning electron microscope images of sintered glass bars prepared from a glass composition of the invention which have been fuel aged at 850° C. at 0 hours (top left), 500 hours (top right), 1000 hours (bottom left) and 2000 hours (bottom right).

FIG. 9 shows scanning electron microscope images of samples before and after fuel aging of a glass composition of the invention.

FIG. 10 is a graph showing percent voltage degradation against the number of thermal cycles of a SOFC stack with a glass composition of the invention subjected to about 100 thermal cycles over about 9000 hours.

FIG. 11 shows optical microscopy images of glass seals prepared from a glass composition of the invention after a SOFC stack test.

### DETAILED DESCRIPTION OF THE EMBODIMENTS

### Definitions

Unless defined otherwise, all technical and scientific terms used herein have the same meaning as commonly understood by those of ordinary skill in the art to which the invention belongs. Although any methods and materials similar or equivalent to those described herein can be used in the practice or testing of the present invention, preferred methods and materials are described. For the purposes of the present invention, the following terms are defined below.

As used herein, the term “about” refers to a quantity, value, dimension, size, or amount that varies by as much as 30%, 25%, 20%, 15% or 10% to a reference quantity, value, dimension, size, or amount.

As used herein, except where the context requires otherwise, the term “comprise” and variations of the term, such as “comprising”, “comprises” and “comprised”, are not intended to exclude further additives, components, integers or steps.

### Glass Composition

The present invention provides a glass composition which comprises, as mol % of the glass composition:
about 50 to about 60 mol % SiO₂;
about 2 to about 10 mol % B₂O₃;
about 0.5 to about 3 mol % Al₂O₃;
about 4 to about 6 mol % TiO₂;
about 1 to about 4 mol % CeO₂;
about 2 to about 30 mol % SrO; and
about 2 to about 25 mol % BaO.

In preferred embodiments of the glass composition, condition (a) and one or both of conditions (b) and (c) are satisfied:

mol % BaO>(2×mol % TiO₂+mol % B₂O₃); (a)

(mol % BaO+mol % SrO−2×mol % TiO₂−mol % B₂O₃)≤0.5×(mol % SiO₂−2×mol % TiO₂−⅔×mol % B₂O₃); (b)

(mol % BaO+mol % SrO−2×mol % TiO₂)/(mol % SiO₂−2×mol % TiO₂)<0.5. (c)

Advantageously, satisfying condition (a) and one or both of conditions (b) and (c) may allow the glass composition to form a glass seal having a glassy phase which is substantially free of BaO and B₂O₃, respectively. As used herein, the term “substantially free” in the context of the glassy phase is intended to mean that the glassy phase does not comprise the specified metal oxide(s) or only comprises the metal oxide(s) in amounts that do not have a measureable effect on the properties and/or performance of the glass seal formed from the glass composition. Therefore, the term “substantially free of BaO and B₂O₃” will be understood to mean that the glassy phase does not comprise BaO or B₂O₃ or comprises BaO and B₂O₃ in amounts that do not have a measureable effect on the properties and/or performance of the glass seal formed from the glass composition. Hence, the glassy phase may comprise small amounts of BaO and/or B₂O₃ provided that these amounts do not have a measureable effect on the properties and/or performance of the glass seal formed from the composition. Without wishing to be bound by theory, the present inventors hypothesise that condition (a) and one or more of conditions (b) and (c) allow substantially all of the BaO and Ba₂O₃, respectively, to be in crystalline form in the glass seal.

In preferred embodiments, the glass composition is substantially free of alkali metal oxides. Glass seals containing alkali metal oxides can be contaminating, electro-chemically unstable and lack robustness, which may lead to degraded performance of a SOFC or SOEC stack, or other electrochemical device requiring a hermetic seal.

The glass composition may optionally comprise no further metal oxides, i.e., no other metal oxides in addition to SiO₂, B₂O₃, Al₂O₃, TiO₂, CeO₂, SrO and BaO. In some embodiments, the glass composition does not comprise CaO. In some embodiments, the glass composition does not comprise ZrO₂.

In some embodiments, the glass composition consists essentially of, or consists of, as mol % of the glass composition:
about 50 to about 60 mol % SiO₂;
about 2 to about 10 mol % B₂O₃;
about 0.5 to about 3 mol % Al₂O₃;
about 4 to about 6 mol % TiO₂;
about 1 to about 4 mol % CeO₂;
about 2 to about 30 mol % SrO; and
about 2 to about 25 mol % BaO. In this context, the terms “consists essentially of” and “consisting of” will be understood to imply that the composition does not include any further metal oxides, that is, the composition only includes the metal oxides specified in the composition.

In these embodiments of the glass composition, preferably condition (a) and one or both of conditions (b) and (c) are satisfied:

mol % BaO>(2×mol % TiO₂+mol % B₂O₃); (a)

(mol % BaO+mol % SrO−2×mol % TiO₂−mol % B₂O₃)≤0.5×(mol % SiO₂−2×mol % TiO₂−⅔×mol % B₂O₃); (b)

(mol % BaO+mol % SrO−2×mol % TiO₂)/(mol % SiO₂−2×mol % TiO₂)<0.5. (c)

The glass composition may contain any suitable range of metal oxide component within the broadest range specified for each metal oxide. The amounts of each metal oxide in the composition may be suitably selected depending on the desired properties of the glass seal to be formed by the glass composition.

In some embodiments, the glass composition comprises, or consists of, one or more of the following, as mol % of the glass composition:
about 52 to about 59 mol % SiO₂, especially about 54 to about 58 mol % SiO₂;
about 3 to about 10 mol % B₂O₃, especially about 5 to about 7 mol % B₂O₃;
about 0.5 to about 2 mol % Al₂O₃, especially about 1 to about 2 mol % Al₂O₃;
about 4 to about 5.5 mol % TiO₂;
about 2 to about 3 mol % CeO₂, especially about 2 to about 2.5 mol % CeO₂;
about 9 to about 20 mol % SrO, especially about 9 to about 12 mol % SrO, more especially about 10 to about 12 mol % SrO, even more especially about 10 to about 11 mol % SrO;
about 15 to about 25 mol % BaO, especially about 16 to about 21 mol % BaO, more especially about 17 to about 20 mol % BaO, even more especially about 17 to about 19 mol % BaO.

The glass composition of the invention may be prepared by methods known in the art. The glass compositions are typically provided in the form of glass powders. The glass can also be provided in frit form, where the glass frit is milled to a powder with desired particle size distribution for use in a sealing material. In brief, the metal oxide components of the glass composition or their precursors are each weighed in correct proportions that would result in the desired glass composition. The weighed powders are mixed to produce a homogeneous mixture and then smelted. The melt is poured onto a suitable surface, such as a marver or a mould, and then rapidly cooled to provide a smelted glass frit. The smelted glass frits may be milled, for example using a ball mill, to produce glass powders. The milled glass powder may be suitably sieved to provide glass powders having the desired particle size or particle size distribution (PSD). The desired PSD may be suitably selected depending on, for example, the technique used to apply the glass seal paste on the components.

The glass composition of the invention may be used for providing a seal in an electrochemical device requiring a hermetic seal. Accordingly, the present invention also provides the use of the glass composition of the invention for forming a seal in an electrochemical device, especially a SOFC or SOEC stack. Advantageously, as shown in the Examples and as described in more detail below, the glass compositions of the invention are capable of forming glass seals which have properties that make them suitable for use in SOFC (and SOEC) stacks.

### Sealing Material

The glass composition of the invention may be used in a sealing material for an electrochemical device requiring a hermetic seal, including a SOFC or SOEC stack. Accordingly, the present invention provides a sealing material comprising the glass composition described herein. The present invention also provides use of the sealing material for forming a seal in an electrochemical device, especially a SOFC or SOEC stack.

The sealing material may comprise one or more fillers. Preferably, the fillers are substantially chemically inert toward the seal formed from the glass composition, which allows the fillers to be used without affecting the performance of the seal. The fillers may also preferably have a CTE similar to that of glass, and/or have high strength. Examples of suitable fillers include, but are not limited to, ZrO₂ in powder or fibre form, ceria and barium silicates.

In some embodiments, the sealing material comprises about 80 to about 100 vol % of the glass composition and about 0 to about 20 vol % of the one or more fillers, based on the total amount of sealing material.

The glass composition of the sealing material may be subjected to a suitable sintering thermal cycle to provide a glass seal for an electrochemical device, especially a SOFC or SOEC stack. A suitable thermal cycle may include a first step which allows the glass powder particles of the glass composition to soften and sinter together to provide a sintered glass having a relatively low viscosity, and a second step which allows the sintered glass to turn into a stable glass-ceramic having a relatively high viscosity by forming crystals of many different compositions. Advantageously, the glass seal formed from the glass composition of the invention may provide the beneficial properties of the both highly glassy seals and highly crystalline seals currently used in SOFC and SOEC stacks.

Accordingly, in some embodiments, the glass composition of the sealing material of the invention, after being subjected to a sintering thermal cycle, softens to provide a sintered glass and subsequently undergoes controlled partial crystallisation to provide a glass-ceramic which comprises one or more crystalline phases and a glassy phase.

In some embodiments, a suitable sintering thermal cycle comprises:
a first step conducted over a period of about 30 to about 120 minutes, especially about 30 to about 60 minutes, and at a temperature which is above the glass transition temperature and is about 10 to about 30° C. below the commencement of the crystallisation of the glass; and
a second step conducted over a period of about 2 to about 5 hours and at a temperature which is at least 50° C. above the intended operating temperature of the electrochemical device, which is especially a SOFC or SOEC stack, and at least 50° C. above the commencement of the crystallisation of the glass.

During the first step, the glass powder particles of the composition soften and sinter together to eliminate interconnected pores and readily flow into the gap(s) between the components of the electrochemical device to be sealed, for example either or both of a cell and an interconnecting support structure of a SOFC/SOEC stack. Advantageously, the sintered glass may establish a hermetic seal between the components of the electrochemical device. The sintered glass may also advantageously provide a strong mechanical bond between the components on either side of the seal. Further, the presence of B₂O₃ in the specified amounts in the glassy phase prior to crystallisation may improve wetting of the electrochemical device components by the glass during the first step, which may advantageously result in strong bonding between the seal and the components. It may be possible for the first step to be conducted over a longer period of time, although this would increase the cost of production. However, conducting the first step for a shorter period of time may result in a poor seal, for example a seal which poorly adheres to other stack components or a seal which is poorly sintered leaving a high level of porosity resulting in a mechanically weak and partially permeable seal. The temperature of the commencement of the crystallisation of the glass may be determined by methods known in the art, for example differential thermal analysis (DTA) and differential scanning calorimetry (DSC).

During the second step, the sintered glass seal partially crystallises to form a stable glass-ceramic comprising one or more crystalline phases and a glassy phase. The crystals of each of the crystalline phases may advantageously increase the mechanical strength of the glass-ceramic. The crystalline phases may also advantageously impart the glass-ceramic with thermal expansion and contraction characteristics that closely match with those of other components of the SOFC or SOEC stack, or other electrochemical device requiring a hermetic seal. The time period for the second step may be suitably selected depending on one or more factors. One factor may be the temperature for the second step, where typically the higher the temperature the lesser the time required. For example, if the temperature of the second step is about 50° C. above the commencement of the crystallisation temperature of the SOFC or SOEC stack, a time period of 2 hours may be sufficient to stabilise the glass by crystallisation. It will be appreciated that a longer time period at a temperature much higher than the intended operating temperature of the SOFC or SOEC stack may cause undesirable and irreversible changes in other components of the stack. It will also be appreciated that a longer time period would increase cost of production. The intended operating temperature of the SOFC or SOEC stack (or other suitable electrochemical device requiring a hermetic seal) may be suitably selected depending on the design of the SOFC or SOEC stack and the characteristics of the other functional components in the stack such as the anode, cathode, electrolyte and metal supports. In some embodiments, the intended operating temperature of the SOFC or SOEC stack (or other suitable electrochemical device requiring a hermetic seal) is from about 500 to about 1000° C., especially from about 500 to about 900° C. The temperature of the commencement of the crystallisation of the glass may be determined by methods known in the art, for example differential thermal analysis (DTA) and differential scanning calorimetry (DSC).

The sintering cycle may optionally include binder burn out step prior to the first and second steps of the sintering thermal cycle. The binder burn out step may be suitably conducted to burn out organic materials present in the seal paste and/or cell coatings. An example of a suitable binder burn out step comprises heating to a temperature of about 445° C. to about 455° C., especially a temperature of about 450° C., over a period of about 0.5 hours.

In some embodiments, the sintered glass, which may be formed from the glass composition of the invention when subjected to a suitable sintering thermal cycle, forms a hermetic seal within the SOFC or SOEC stack, or other electrochemical device requiring a hermetic seal.

In some embodiments, the glass-ceramic, which may be subsequently formed from the sintered glass, comprises one or more crystalline phases and a glassy phase. In some embodiments, the glass-ceramic comprises about 45 to about 80 vol %, especially about 50 to about 70 vol %, of the one or more crystalline phases and about 20 to about 55 vol %, especially about 30 to about 50%, of the glassy phase, based on the total amount of glass-ceramic.

In some embodiments, the one or more crystalline phases of the glass-ceramic comprise crystals having a structure selected from 2BaO·TiO₂·2SiO₂, 2SrO·TiO₂·2SiO₂, 3BaO·3B₂O₃·2SiO₂, BaO·2SiO₂, BaO·B₂O₃, and combinations thereof.

The BaO of the glass composition may be consumed during crystallisation of the sintered glass to the glass-ceramic such that substantially all of the BaO is in crystalline form in the glass-ceramic. Similarly, the B₂O₃ of the glass composition may be consumed during crystallisation such that substantially all of the B₂O₃ is in crystalline form in the glass-ceramic. Accordingly, in some embodiments, the glassy phase of the glass-ceramic is substantially free of BaO. In some embodiments, the glassy phase of the glass-ceramic is substantially free of B₂O₃. Advantageously, this may provide a highly viscous silicate glass matrix of low reactivity. This is because BaO and B₂O₃ in the glassy phase may have adverse interactions with other components of the SOFC or SOEC, or other electrochemical device requiring a hermetic seal, but may become essentially inert when crystallised. In this context, “essentially inert” is intended to mean that the BaO and/or B₂O₃ when crystallised do not react with other components of the electrochemical device or only react in such a way that does not have a measureable effect on the properties and/or performance of the glass seal formed from the glass composition.

The glass-ceramic may preferably have thermal expansion and contraction characteristics that closely match with those of other components of the electrochemical device, which is especially a SOFC or SOEC stack, in the range of temperatures where the glass is rigid, i.e., below the glass transition temperature. This may advantageously allow the thermal stresses generated during the operation of the electrochemical device to not exceed the mechanical strengths of the components of the electrochemical device. Accordingly, in some embodiments, the glass-ceramic has a thermal expansion and contraction mismatch with any other stack component it is bonded to of about −0.04 (negative 0.04) to about 0.10 (positive 0.10) at any temperature up to the glass transition temperature of the glassy phase, where the thermal expansion and contraction mismatch is defined as:

$$Expansion Difference \% = \{ ( {[ \frac{Δ L}{L} ]}_{Glass @ T} - {[ \frac{Δ L}{L} ]}_{Other @ T} ) - ( {[ \frac{Δ L}{L} ]}_{Glass @ Tg} - {[ \frac{Δ L}{L} ]}_{Other @ Tg} ) \} \times 100$$

where Glass refers to the glass-ceramic and Other refers to the other electrochemical device component the glass is bonded to (for example, in the case of a SOFC or SOEC stack, either or both of a cell and an interconnecting support structure). The glass transition temperature of the glassy phase is dependent on its composition and may be determined by methods known in the art, for example by conducting a dilatometry test. Advantageously, as shown in the Examples, glass samples prepared from the glass compositions of the invention showed stable expansion mismatch when subjected to an air environment or a fuel environment at elevated temperatures for extended periods of time.

The glass-ceramic may have a coefficient of thermal expansion (CTE) which allows the glass-ceramic (and therefore the sealing material) to be suitable for use in an electrochemical device requiring a hermetic seal, especially a SOFC or SOEC stack. The CTE may be substantially the same as the CTE of any of the other components in the SOFC or SOEC stack, or other electrochemical device requiring a hermetic seal. In some embodiments, the glass-ceramic (or the sealing material) has a CTE of about 10×10⁻⁶/° C. to about 13×10⁻⁶/° C.

The sealing material of the invention may be useful for forming a glass seal in an electrochemical device requiring a hermetic seal, especially a SOFC or SOEC stack. Accordingly, the present invention provides an electrochemical device, preferably a SOFC or SOEC stack, comprising one or more cells, each cell comprising a cathode, an anode and a solid electrolyte; a support structure comprising one or more supports; and the sealing material described herein. The present invention also provides an electrochemical device, preferably a SOFC or SOEC stack, comprising one or more cells, each cell comprising a cathode, an anode and a solid electrolyte, a support structure comprising one or more supports, and a glass seal, wherein the glass seal is formed from the sealing material described herein. The glass seal may be formed using a suitable sintering thermal cycle as described herein. The support structure is an interconnected support structure which comprises one or more supports made of a suitable material, for example made of a suitable metal such as steel. In some embodiments, the support structure is a set of interconnected plates. It will be understood that each plate may be interpreted as a support of the support structure, and each cell may comprise one or more of the plates.

The present invention also provide a method of forming a seal in an electrochemical device which is a SOFC or SOEC stack, the method comprising:
applying the sealing material described herein on either or both of a cell and a support structure of an SOFC or SOEC stack; and
subjecting the sealing material to a sintering thermal cycle, wherein the glass composition of the sealing material softens to provide a sintered glass and subsequently undergoes controlled crystallisation to provide a glass-ceramic comprising one or more crystalline phases and a glassy phase;

thereby forming a seal in the SOFC or SOEC stack.

Suitable sintering thermal cycles which may be used in the method of the invention and features and properties of the sealing material (or sintered glass, glass-ceramic or glass seal formed therefrom) are as described herein.

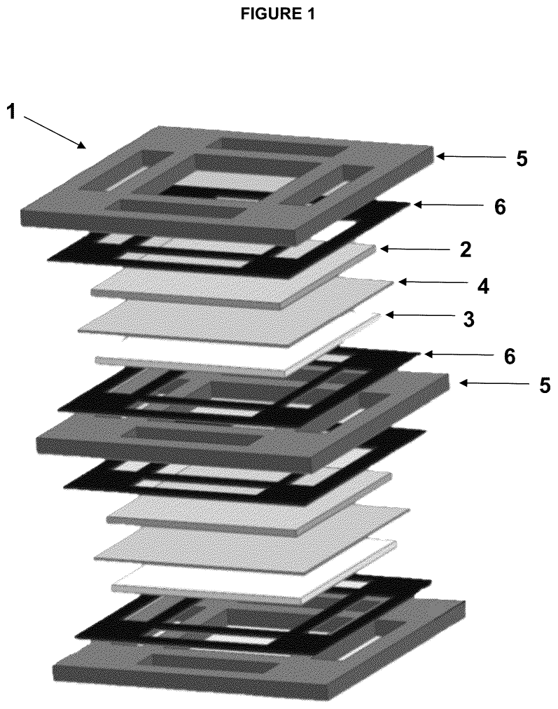

An example of a SOFC stack is shown in FIG. 1, which is a schematic diagram of a portion of a SOFC stack (1) with cell components, namely the cathode (2), anode (3) and electrolyte (4), support structure (5) and glass seal (6) shown in an exploded view.

Advantageously, as shown in the Examples, SOFC stacks operated at standard operating temperatures over extended periods of time which were sealed with the glass composition of the invention degraded less than those sealed from a comparative glass currently used in the production of SOFC stacks. Accordingly, in some embodiments, the SOFC (or SOEC) stacks of the invention undergo a total performance degradation of less than 10%, especially less than 6%, more especially less than about 3%, even more especially less than about 2%, when operated for about 10,000 hours and subjected to about 100 thermal cycles from room temperature (about 20° C. to about 25° C.) to the intended operating temperature of the SOFC (or SOEC) stack.

It will be understood that the invention disclosed and defined in this specification extends to all alternative combinations of two or more of the individual features mentioned or evident from the text or drawings. All of these different combinations constitute various alternative aspects of the invention.

### EXAMPLES

The invention will be further described by way of non-limiting example(s). It will be understood to persons skilled in the art of the invention that many modifications may be made without departing from the spirit and scope of the invention.

### Example 1. Glass Compositions and Powders

To identify glass seals which may be suitable for electrochemical devices such as SOFC and SOEC stacks, 19 different glass compositions were assessed. The glass compositions are provided in Table 1.

TABLE 1
Glass compositions

| | Metal oxide (mol %) | | | | | | | Condition | | |
|---|---|---|---|---|---|---|---|---|---|---|
| Comp | SiO₂ | B₂O₃ | Al₂O₃ | TiO₂ | CeO₂ | SrO | BaO | (a) | (b) | (c) |
| 1 | 52.76 | 9.25 | 0.78 | 5.20 | 2.63 | 11.57 | 17.82 | −1.84 | 0.27 | 0.45 |
| 2 | 58.31 | 2.77 | 2.44 | 5.20 | 2.60 | 11.03 | 17.65 | 4.47 | 0.34 | 0.38 |
| 3 | 59.03 | 3.99 | 0.88 | 5.11 | 2.62 | 11.12 | 17.24 | 3.03 | 0.31 | 0.37 |
| 4 | 53.68 | 9.35 | 0.86 | 5.25 | 2.53 | 11.04 | 17.29 | −2.56 | 0.23 | 0.41 |
| 5 | 53.08 | 8.93 | 1.88 | 5.08 | 2.56 | 10.95 | 17.52 | −1.58 | 0.25 | 0.43 |
| 6 | 52.16 | 8.93 | 2.49 | 5.19 | 2.61 | 11.06 | 17.56 | −1.74 | 0.26 | 0.44 |
| 7 | 58.00 | 2.97 | 1.37 | 5.18 | 2.54 | 11.12 | 18.83 | 5.50 | 0.36 | 0.41 |
| 8 | 58.37 | 3.38 | 0.87 | 5.16 | 2.53 | 10.98 | 18.72 | 5.02 | 0.35 | 0.40 |
| 9 | 57.35 | 2.99 | 2.35 | 5.12 | 2.48 | 11.06 | 18.65 | 5.42 | 0.37 | 0.41 |
| 10 | 52.94 | 8.23 | 2.38 | 5.05 | 2.45 | 10.81 | 18.14 | −0.18 | 0.28 | 0.44 |
| 11 | 54.30 | 6.53 | 1.65 | 5.05 | 2.48 | 11.32 | 18.67 | 2.05 | 0.34 | 0.45 |
| 12 | 57.35 | 5.92 | 1.63 | 4.99 | 2.49 | 10.16 | 17.46 | 1.56 | 0.27 | 0.37 |
| 13 | 56.20 | 6.23 | 1.61 | 4.99 | 2.47 | 10.70 | 17.80 | 1.60 | 0.29 | 0.40 |
| 14 | 56.21 | 6.25 | 1.65 | 5.11 | 2.47 | 10.74 | 17.57 | 1.10 | 0.28 | 0.39 |
| 15 | 56.21 | 6.27 | 1.63 | 5.05 | 2.50 | 10.73 | 17.60 | 1.22 | 0.29 | 0.40 |
| 16 | 55.69 | 6.23 | 1.68 | 5.06 | 2.47 | 10.77 | 18.09 | 1.73 | 0.30 | 0.41 |
| 17 | 57.32 | 4.54 | 1.59 | 5.02 | 2.48 | 10.90 | 18.14 | 3.56 | 0.33 | 0.40 |
| 18 | 55.86 | 6.24 | 1.99 | 5.11 | 2.48 | 10.93 | 17.39 | 0.93 | 0.29 | 0.40 |
| 19 | 51.73 | 7.85 | 1.75 | 5.05 | 2.45 | 28.70 | 2.47 | −15.49 | 0.36 | 0.51 |

Condition (a): (BaO − 2*TiO₂ − B₂O₃). Glass compositions having a value >0 satisfy this requirement. For glass compositions that satisfy this requirement, substantially all B₂O₃ is expected to be in crystalline form in the glass-ceramic formed from those glass compositions.
Condition (b): (BaO + SrO − 2*TiO₂ − B₂O₃)/(SiO₂ − 2*TiO₂ − 2*B₂O₃/3). Glass compositions having a value ≤0.5 satisfy this requirement. For glass compositions that satisfy this requirement, substantially all BaO is expected to be in crystalline form in the glass-ceramic formed from those glass compositions.
Condition (c): (BaO + SrO − 2*TiO₂)/(SiO₂ − 2*TiO₂). Glass compositions having a value <0.5 satisfy this requirement. For glass compositions that satisfy this requirement, substantially all BaO is expected to be in crystalline form in the glass-ceramic formed from those glass compositions.

Glass powders corresponding to glass compositions 1-19 were prepared by the following method. Oxides of each metal component or their precursors were weighed in correct proportion that would result in the desired glass composition. The weighed powders were thoroughly mixed to produce a homogeneous mixture and smelted at 1450° C. for 2 h. Once the raw materials were converted to a melt, it was poured onto a marver and then rapidly cooled in water to produce a glass frit.

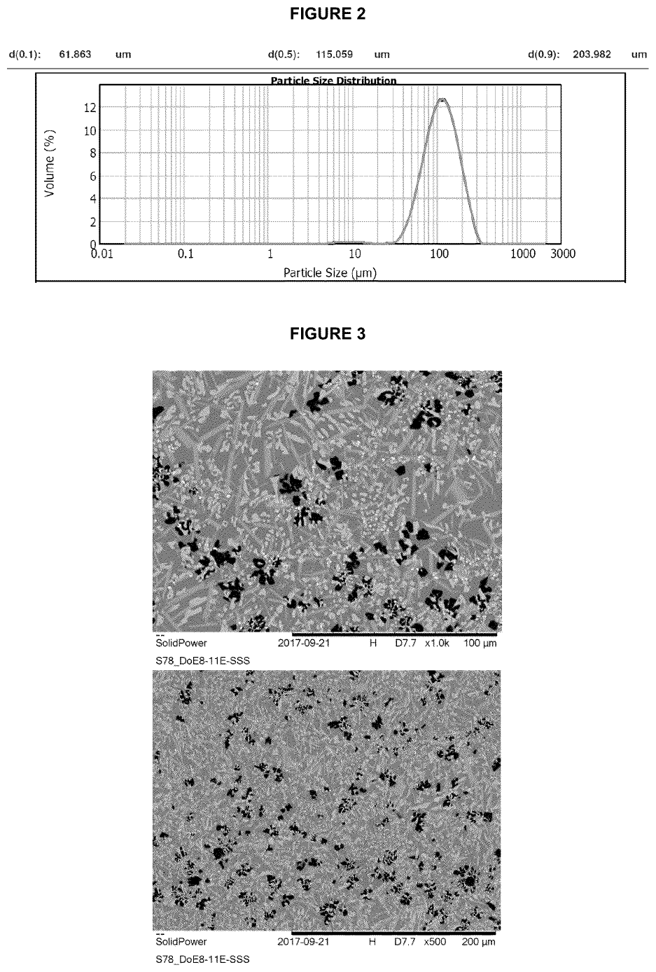

The smelted glass frits were dried and ball milled and sieved to provide glass powders with the desired particle size distribution (PSD). The particle sizes fall within the ranges shown in Table 2. The measurement was performed using a laser diffraction method and the typical particle size distribution of the glass powder is shown in FIG. 2.

TABLE 2
Particle size distribution of glass powders

| | Size (μm) |
|---|---|
| d10 | 58-68 |
| d50 | 110-120 |
| d90 | 200-220 |

Chemical analysis of the glass powders was carried out using Inductively Coupled Plasma (ICP) spectroscopy according to ASTM International Standard Designation C1463—13 to confirm the composition of each glass powder. The slightly modified procedure was used to prepare the samples for ICP analysis—the sample solutions were prepared according to section 22.2 of C1463—13 except that in section 22.2.8 nitric acid was used instead of a hydrochloric acid and oxalic acid mixture.

### Example 2. Characterisation of Sintered Glass by SEM and XRD

Scanning Electron Microscopy (SEM) was carried out to determine the microstructure of sintered glass samples. To prepare sintered glass samples, glass powders corresponding to compositions 1-19 of Table 1 prepared by the procedure described in Example 1 were sintered by a two-step sintering thermal cycle to produce sintered bars. A temperature profile identical to SOFC stack sintering profile was used to ensure that the microstructure of the sintered samples were similar to that of seals in a sintered stack.

The microstructure of a sintered glass sample corresponding to glass composition 11 at two different magnifications is shown in FIG. 3. The microstructure indicates that the sintered glass has several different crystalline phases and a glassy phase. Some of the crystalline phases identified by X-ray diffraction include 2BaO·TiO₂·2SiO₂, 2SrO·TiO₂·2SiO₂, and BaO·2SiO₂.

### Example 3. Characterisation of Sintered Glass by Dilatometry

The expansion mismatch between the sintered glass bars and the stack interconnecting stainless steel was determined using dilatometry. Sintered glass bar samples corresponding to glass compositions 1-19 of Table 1 were prepared using the procedures described in Examples 1 and 2.

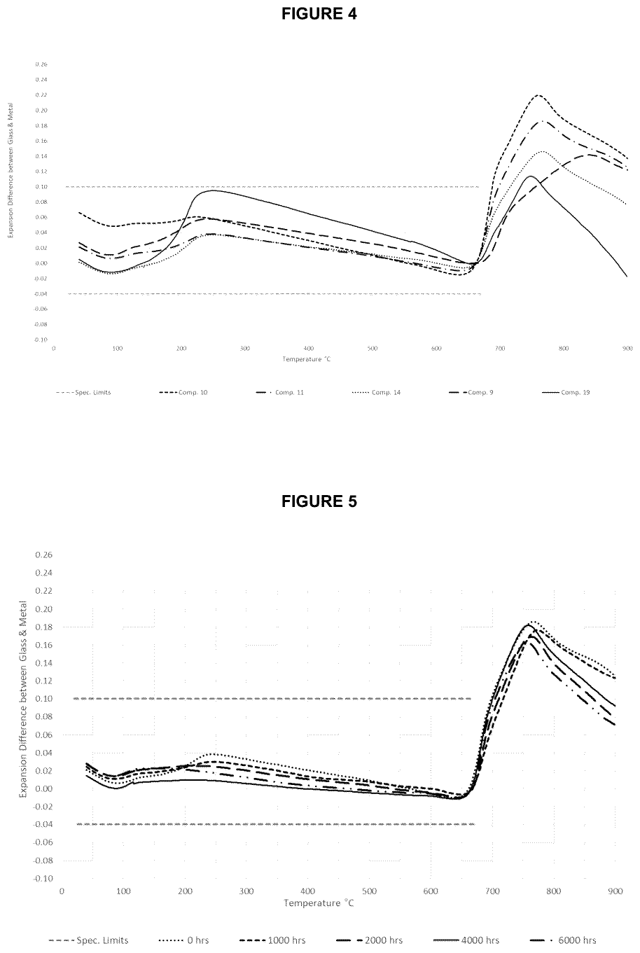

FIG. 4 shows the expansion mismatch of sintered glass bar samples 9, 10, 11, 14 and 19 against the stainless steel metal support material given by the following equation:

$$Expansion Difference \% = \{ ( {[ \frac{Δ L}{L} ]}_{Glass @ T} - {[ \frac{Δ L}{L} ]}_{Other @ T} ) - ( {[ \frac{Δ L}{L} ]}_{Glass @ Tg} - {[ \frac{Δ L}{L} ]}_{Other @ Tg} ) \} \times 100$$

where Glass is the sintered glass bar sample and Other is the stainless steel material. The two dotted lines in FIG. 4 encapsulate the preferred region where expansion mismatch is to be between room temperature and the glass transition temperature for the stresses within the stack to be minimized for its safe operation and thermal cycling. The results show that glass compositions 9, 10, 11, 14 and 19 exhibited expansion differences with the metal support which fall within the two dotted lines and therefore fall within the defined range. Accordingly, the results may indicate that glass compositions 9, 10, 11, 14 and 19 provide a glass having thermal expansion and contraction characteristics that closely match with those of other components of an SOFC (or SOEC) stack in the range of temperatures where the glass is rigid, i.e., below the glass transition temperature.

### Example 4. Characterisation of Air-aged Sintered Glass

The suitability of the glass powders for sealing SOFC stacks was assessed by aging the sintered glass bars in an air environment at elevated temperatures. Sintered glass bar samples corresponding to glass compositions 1-19 of Table 1 were prepared using the procedures described in Example 1 and 2. The sintered glass bars were aged in an atmospheric air environment at 850° C. for 0, 1000, 2000, 4000 and 6000 hours and then the microstructure and expansion mismatch were characterised.

FIG. 5 shows the expansion mismatch of sintered bars prepared from glass composition 11 subjected to an atmospheric air environment at 850° C. for 0, 1000, 2000, 4000 and 6000 hours. The air aged samples of glass composition 11 showed relatively stable expansion mismatch with the metal over the extended time period.

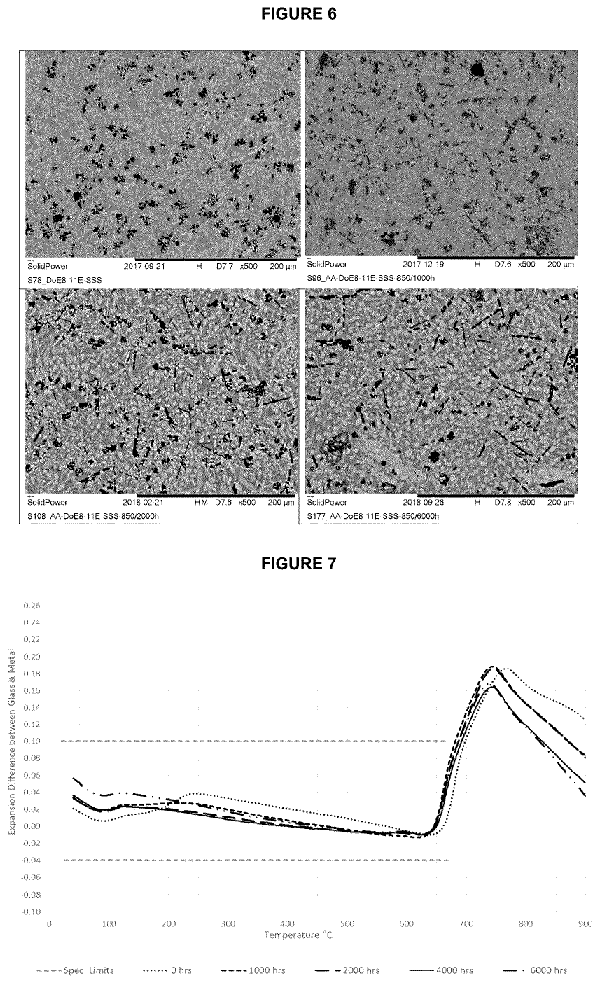

FIG. 6 shows SEM micrographs of the air aged samples of glass composition 11. SEM analysis showed that the crystals of the initially formed crystalline phases had coarsened while small amounts of some new crystal types had grown over the exposure time but generally the glass remained pore free where formation of pores could contribute to seal failure.

### Example 5. Characterisation of Fuel-aged Sintered Glass

The suitability of the glass powders for sealing SOFC stacks was assessed by aging the sintered glass bars in a fuel environment at elevated temperatures. Sintered glass bar samples corresponding to glass compositions 1-19 of Table 1 were prepared using the procedure described in Examples 1 and 2. The sintered glass bars were aged in a 60% H₂+40% steam environment at 850° C. for similar time periods as in air aging test.

FIG. 7 shows the expansion mismatch of sintered bars prepared from glass composition 11 subjected to a fuel environment at 850° C. for 0, 1000, 2000, 4000 and 6000 hours. Although the fuel environment is more reactive towards glass compared to air, the expansion mismatch of the fuel aged samples of glass composition 11 remained relatively stable over the extended time period.

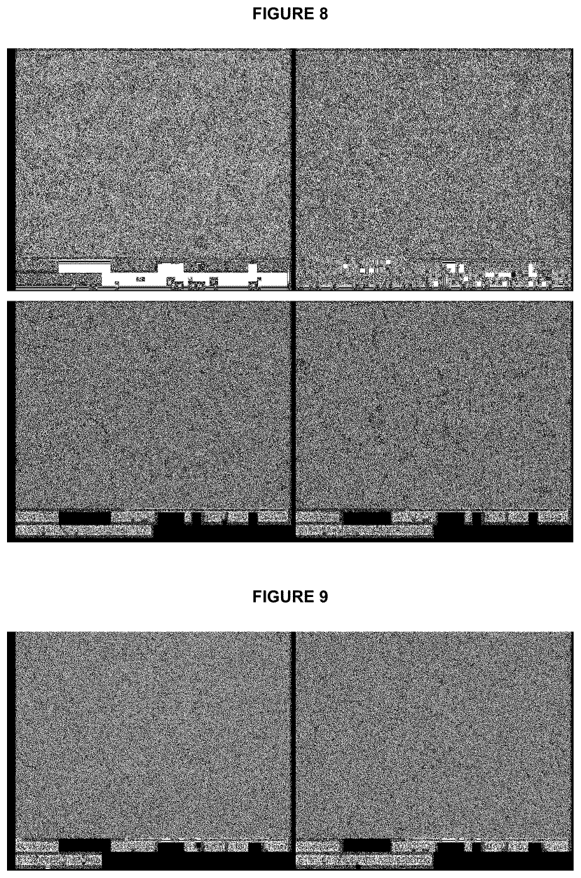

FIG. 8 shows SEM micrographs of the fuel aged samples of glass composition 11. SEM analysis indicated some growth of crystals, but not as much as in the air aged samples. It was observed that there was some level of porosity growth in the glass, although this was minimal as shown in FIG. 9.

### Example 6. Validation of Glass as a Seal for SOFC Stacks

Glass compositions 11, 14 and 18 of Table 1 were selected for validation as a seal for SOFC stacks. Glass powder from each composition was converted to a paste with a suitable binder/solvent system, applied onto stack parts where a seal is required (either on the cell and/or interconnecting support structure), stacked to build a stack and then sintered with a suitable sintering temperature program as described in paragraph [0048] above to provide a SOFC stack with a hermetic seal. It is noted that the stack sintering cycle included a binder burnout step as described in paragraph above in addition to the two steps required for glass sealing, to burn out organic materials present in the seal paste and the cell coatings.

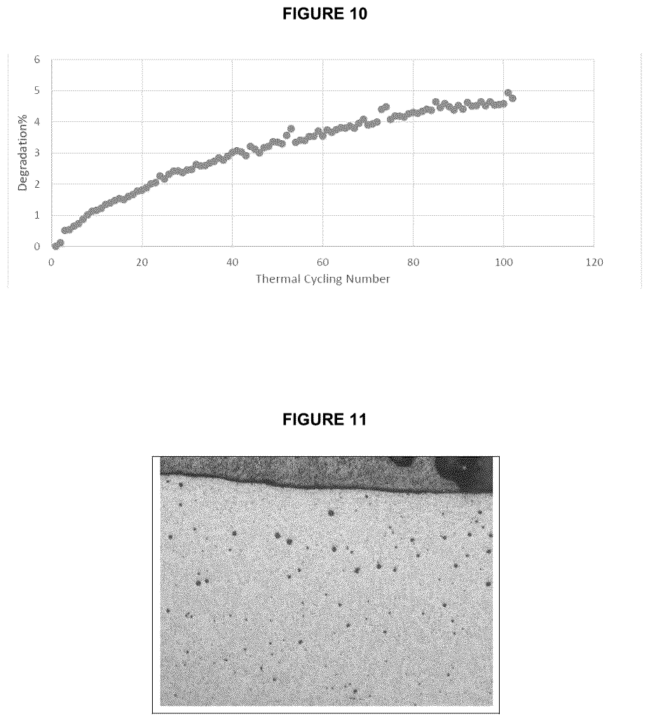

The stacks were operated at standard stack operating temperature of 750° C. and subjected to about 100 thermal cycles over about 9000 hours. The summary of percent voltage degradation results for the stacks is provided in Table 3 and the percent voltage degradation of the stack with glass composition 18 with each thermal cycle is shown in FIG. 10. The degradation % per thermal cycle includes both intrinsic degradation of the stack and the degradation purely due to thermal cycling, that is, degradation of the stack under normal operation as well as degradation due to thermal cycling combined together and normalised to number of thermal cycles the stack was subjected to. It is noted that if no thermal cycles had been conducted, the percent degradation would be expected to be less.

TABLE 3
Summary of percent degradation results for tested stacks

| Glass composition used | | Average deg % per |
|---|---|---|
| to form the seal | Duration of test (h) | thermal cycle |
| 11 | 9800 | 0.044% |
| 14 | 9400 | 0.041% |
| 18 | 9200 | 0.047% |

The glass seals from the tested stacks were examined for porosity growth. Glass seals near the fuel exhaust in the stack were selected for the analysis as they were subjected to most reactive environment. Level of porosity can be determined by image analysis. An acceptable level of porosity can depend on many factors including the strength of the seal, level of thermal stresses generated which in turn depends on the CTE mismatch between glass and other components. Continuous porosity growth in a glass eventually leads to seal failure. Therefore, the useful life of a stack typically increases with the decrease in the rate of pore formation and growth.

FIG. 11 shows an optical microscopy image of the glass seal taken from the stack with glass composition 18 tested for 9200 hours. The image indicates that the glass seal exhibited minimal porosity growth.

1. A glass composition comprising, as mol % of the glass composition:
about 50 to about 60 mol % SiO₂;
about 2 to about 10 mol % B₂O₃;
about 0.5 to about 3 mol % Al₂O₃;
about 4 to about 6 mol % TiO₂;
about 1 to about 4 mol % CeO₂;
about 2 to about 30 mol % SrO; and
about 2 to about 25 mol % BaO.

2. The glass composition of claim 1, wherein condition (a) and one or both of conditions (b) and (c) are satisfied:
mol % BaO>(2×mol % TiO2+mol % B₂O₃); (a)
(mol % BaO+mol % SrO−2×mol % TiO₂−mol % B₂O₃)≤0.5×(mol % SiO₂−2×mol % TiO₂−⅔×mol % B₂O₃); (b)
(mol % BaO+mol % SrO−2×mol % TiO₂)/(mol % SiO₂−2×mol % TiO₂)<0.5. (c)

3. The glass composition of claim 1, wherein further the glass composition is substantially free of alkali metal oxides.

4. The glass composition of claim 1, wherein further the glass composition does not comprise CaO.

5. The glass composition of claim 1, wherein further the glass composition does not comprise ZrO₂.

6. The glass composition of claim 1, wherein further the glass composition comprises one or more of the following, as mol % of the glass composition:
about 52 to about 59 mol % SiO₂;
about 3 to about 10 mol % B₂O₃;
about 0.5 to about 2 mol % Al₂O₃;
about 4 to about 5.5 mol % TiO₂;
about 2 to about 3 mol % CeO₂;
about 9 to about 20 mol % SrO;
about 16 to about 21 mol % BaO.

7. The glass composition of claim 1, wherein further the glass comprises one or more of the following, as mol % of the glass composition:
about 54 to about 58 mol % SiO₂;
about 5 to about 7 mol % B₂O₃;
about 1 to about 2 mol % Al₂O₃;
about 4 to about 5.5 mol % TiO₂;
about 2 to about 3 mol % CeO₂;
about 10 to about 12 mol % SrO;
about 17 to about 19 mol % BaO.

8. A glass composition consisting essentially of, as mol % of the glass composition:
about 50 to about 60 mol % SiO₂;
about 2 to about 10 mol % B₂O₃;
about 0.5 to about 3 mol % Al₂O₃;
about 4 to about 6 mol % TiO₂;
about 1 to about 4 mol % CeO₂;
about 2 to about 30 mol % SrO; and
about 2 to about 25 mol % BaO.

9. The glass composition of claim 8, wherein condition (a) and one or both of conditions (b) and (c) are satisfied:
mol % BaO>(2×mol % TiO₂+mol % B₂O₃); (a)
(mol % BaO+mol % SrO−2×mol % TiO₂−mol % B₂O₃)≤0.5×(mol % SiO₂−2×mol % TiO₂−⅔×mol % B₂O₃); (b)
(mol % BaO+mol % SrO−2×mol % TiO₂)/(mol % SiO₂−2×mol % TiO₂)<0.5. (c)

10. A sealing material for use in an electrochemical device, comprising the glass composition of claim 1.

11. The sealing material of claim 10, wherein the sealing material further comprises one or more fillers.

12. The sealing material of claim 11, wherein the sealing material comprises about 80 to about 100 vol % of the glass composition and about 0 to about 20 vol % of the one or more fillers, based on the total amount of sealing material.

13. The sealing material of claim 10, wherein further the glass composition, after being subjected to a sintering thermal cycle, softens to provide a sintered glass and subsequently undergoes controlled crystallisation to provide a glass-ceramic comprising one or more crystalline phases and a glassy phase.

14. The sealing material of claim 13, wherein the sintering thermal cycle comprises:
a first stage conducted over a period of about 30 to about 120 minutes and at a temperature which is above the glass transition temperature and is about 10 to about 30° C. below the commencement of the crystallisation of the glass; and
a second stage conducted over a period of about 2 to about 5 hours and at a temperature which is at least 50° C. above the intended operating temperature of the electrochemical device and at least 50° C. above the commencement of the crystallisation of the glass.

15. The sealing material of claim 13, wherein the sintered glass forms a hermetic seal with the electrochemical device.

16. The sealing material of claim 13, wherein further the glass-ceramic comprises about 45 to about 80 vol % of the one or more crystalline phases and about 20 to about 55 vol % of the glassy phase, based on the total amount of glass-ceramic.

17. The sealing material of claim 13, wherein further the one or more crystalline phases of the glass-ceramic each comprise crystals having a structure selected from 2BaO·TiO₂·2SiO₂, 2SrO·TiO₂·2SiO₂, 3BaO·3B₂O₃·2SiO₂, BaO·2SiO₂, BaO·B₂O₃, and combinations thereof.

18. The sealing material of claim 10, wherein further the glass-ceramic has a thermal expansion and contraction mismatch with any other stack component it is bonded to, defined as:
$$Expansion Difference \% = \{ ( {[ \frac{Δ L}{L} ]}_{Glass @ T} - {[ \frac{Δ L}{L} ]}_{Other @ T} ) - ( {[ \frac{Δ L}{L} ]}_{Glass @ Tg} - {[ \frac{Δ L}{L} ]}_{Other @ Tg} ) \} \times 100$$
of about −0.04 to about 0.10 at any temperature up to the glass transition temperature of the glassy phase.

19. The sealing material of claim 10, wherein further the glassy phase of the glass-ceramic is substantially free of BaO.

20. The sealing material of claim 10, wherein further the glassy phase of the glass-ceramic is substantially free of B₂O₃.

21. The sealing material of claim 10, wherein further the glass-ceramic has a coefficient of thermal expansion (CTE) of about 10×10⁻⁶/° C. to about 13×10⁻⁶/° C.

22. An electrochemical device comprising one or more cells, each cell comprising a cathode, an anode and a solid electrolyte; a support structure comprising one or more supports; and the sealing material of claim 10.

23. The electrochemical device of claim 22, wherein the electrochemical device is a SOFC or SOEC stack.

24. The glass composition of claim 1, wherein the glass composition forms a seal in an electrochemical device.

25. A method of forming a seal in an electrochemical device which is a SOFC or SOEC stack, the method comprising:
applying the sealing material of claim 10 on either or both of a cell and a support structure of an SOFC or SOEC stack; and
subjecting the sealing material to a sintering thermal cycle, wherein the glass composition of the sealing material softens to provide a sintered glass and subsequently undergoes controlled crystallisation to provide a glass-ceramic comprising one or more crystalline phases and a glassy phase;
thereby forming a seal in the SOFC or SOEC stack.
